(19) United States
(12) Patent Application Publication
(10) Pub. No.: US 2026/0162245 A1
(43) Pub. Date: Jun. 11, 2026

(54) METHOD SEQUENCE FOR AUTOMATED NONDESTRUCTIVE MATERIAL TESTING

(71) Applicant: Siemens Energy Global GmbH & Co. KG, Munich, Bayern (DE)

(72) Inventors: Timo Heitmann, Berlin (DE); Jonas Wild, Berlin (DE); Ole Geisen, Berlin (DE); Sebastian Wallich, Bad Belzig (DE)

(73) Assignee: Siemens Energy Global GmbH & Co. KG, Munich, Bayern (DE)

(21) Appl. No.: 18/709,489

(22) PCT Filed: Sep. 28, 2022
(86) PCT No.: PCT/EP2022/076919

§ 371 Date: May 11, 2024

(30) Foreign Application Priority Data
Nov. 18, 2021 (DE) 10 2021 212 956.0
Dec. 7, 2021 (DE) 10 2021 213 897.7

(51) Int. Cl. G06T 7/00; B33Y 50/00; G01N 23/046; G01N 23/18; G06T 7/38; G06T 7/62; G06T 12/30; G06T 19/20

(52) U.S. Cl. CPC G06T 7/001; B33Y 50/00; G01N 23/046; G01N 23/18; G06T 7/38; G06T 7/62; G06T 12/30; G06T 19/20; G01N 2223/401; G01N 2223/63; G06T 2207/20081; G06T 2207/30144; G06T 2219/2016

(57) ABSTRACT

A method for nondestructive material testing includes (i) providing a target geometry (CAD) of a component with the aid of a 3D data model of the component, (ii) providing measurement data of the component, the measurement data being generated by an imaging method, (iii) superposing the 3D data model with the measurement data of the component, (iv) providing 2D model slices by cutting the data model superposed with the measurement data, and (v) examining each of the 2D model slices by an automatic image analysis for structural differences between the data model and the measurement data. A corresponding device, a corresponding computer program product, and a providing device therefor are furthermore specified.

### CROSS REFERENCE TO RELATED APPLICATIONS

This application is the US National Stage of International Application No. PCT/EP 2022/076919 filed 28 Sep. 2022, and claims the benefit thereof, which is incorporated by reference herein in its entirety. The International Application claims the benefit of German Application No. DE 10 2021 212 956.0 filed 18 Nov. 2021 and of German Application No. DE 10 2021 213 897.7 filed 7 Dec. 2021.

### FIELD OF INVENTION

The present invention relates to a method of material testing, in particular nondestructive material testing, preferably for components produced additively from the powder bed. By preference, the method also relates to an improved, automated procedure for particularly complex or thin-walled component geometries.

### BACKGROUND OF INVENTION

The design and material properties of high-performance machine components are the subject of continuous development in order to increase or expand the functionality and/or fields of use of the corresponding components in use. In the case of heat engines, especially gas turbine, the development frequently targets ever higher use temperatures. For example, in order to meet the challenges of changing industrial requirements, the development seeks in particular an increase in solidity or an improved ability to withstand thermal loads and a lengthened service life of such component structures.

The described components can preferably be provided for use in the hot gas path of a gas turbine. For example, the component relates to a component to be cooled having a thin-walled or delicate design. As an alternative or in addition, the component can be a component part for use in the automotive industry or in the aircraft sector.

On account of technical developments, generative or additive manufacturing is increasingly also of interest for the series production of the aforementioned components, for example turbine blades or heat transmitters.

Additive manufacturing (AM) methods, colloquially also referred to as 3-D printing, for example comprise, as powder bed methods (“PBF” for powder bed fusion), selective laser melting (SLM) or laser sintering (SLS), or electron beam melting (EBM). In particular, additive manufacturing methods were found to be particularly advantageous for complex or delicately designed components, for example labyrinthine structures, cooling structures and/or lightweight structures. In particular, additive manufacturing is advantageous due to a particularly short process step chain as a production or manufacturing step for a component can be implemented largely on the basis of a corresponding CAD file and the choice of appropriate manufacturing parameters.

Alternatively, the present methodology according to the invention can be applied without loss of generality-to other components and differently produced components, for example components produced conventionally or by machining.

In any case, special advantages according to the invention become apparent in the case of complicated and delicate component shapes in particular, independently of the chosen production route.

In recent developments, particularly thin-walled components have been able to be obtained particularly advantageously by the use of novel pulse-modulating or pulsing LPBF (laser powder bed fusion) methods, which allow the generation of particularly small melt pools and hence also particularly thin structures or features. In particular, there is the option of producing walls with a thickness of between 0.1 mm and 0.2 mm (100-200 μm), something that is particularly advantageous in the case of functional cooling structures, heat exchangers or heat transmitters, for example.

For such components, it is also particularly important to subsequently test quality and density since defects can arise quickly in the case of the aforementioned wall thicknesses and significantly restrict the usability in components that might be subject to high thermal and mechanical loads during operation.

### SUMMARY OF INVENTION

It is therefore an object of the present invention to present an improved procedure for nondestructive material testing, preferably automated nondestructive material testing. In particular, this can decisively improve, or for the first time validate, the quality assurance for (additively and/or industrially manufactured) thin-walled and delicate components.

This object is achieved by the subject matter of the independent claims. Advantageous configurations are the subject matter of the dependent claims.

One aspect of the present invention relates to a method of (computer-implemented) nondestructive material testing, in particular within the scope of additive, powder bed-based manufacturing.

The method comprises the provision of a target geometry, for example the corresponding component design, with the aid of a (CAD) 3-D data model of the component.

The method also comprises the provision of measured data of the component, the measured data being generated or produced by an imaging method, for example by approaches using computer tomography, nuclear magnetic resonance or the like.

The method also comprises the overlay of the measured data of the component on the 3D data model, or the alignment thereof.

The method also comprises the provision of (virtually 2-D) model slices by cutting or slicing the data model with the overlaid measured data. The model slices or corresponding layer information, model data or measured data can be available two-dimensionally by preference, i.e. without height, depth or volume information.

The method also comprises the examination of each 2-D model slice or of slice data for differences, for example structural differences, or deviations (defects) between the data model and the measured data using an automated image analysis.

This procedure advantageously presents a quasi-automated solution for quality assurance of very complex, thin-walled and/or periodic structures. The check of the components in question for structural defects or for sufficient quality or with regards to the dimensional conformance inspection frequently cannot be performed manually with justifiable outlay.

In one configuration, the target geometry is provided by a 3-D CAD data record.

In one configuration, the measured data are generated by a tomographic method, in particular computed tomography or a comparable method suitable for nondestructive material testing.

In one configuration, the overlay comprises or represents an alignment of the 3-D data model with the measured data of the component by way of a compensating adaptation (a so-called “best fit”).

In one configuration, a layer or slice spacing between individual layers of the data model corresponds to a value of, or is, roughly between 0.01 mm and 0.05 mm. This configuration is particularly preferred since the slice spacing thus can be adapted expediently and usefully to a layer subdivision, which for example is implemented by way of production-preparing CAM methods, or to an expedient resolution limit of structure defects to be examined.

In one configuration, the automated image analysis for the examination of each model slice includes distinguishing between solid and hollow component features. This configuration expediently allows implementation of a correction of fusion artifacts or unwanted powder or particle agglomerations by way of the described alignment.

In one configuration, the automated image analysis for the examination of each model slice includes measuring an area enclosed by component features or hollow structures and performing an area adjustment with the data model (target/actual comparison). Structure defects can be detected and identified particularly advantageously and reliably-by measures from automated pattern recognition, image processing-by way of the area adjustment.

In one configuration, a component material, a scanning parameter, for example an irradiation power or an irradiation pattern, and/or a position of the component, for example in the installation space of a corresponding additive manufacturing apparatus, are given consideration during the measurement of the area.

In one configuration, machine learning methods or comparable image processing or pattern recognition approaches are applied during the automated image analysis.

In one configuration, the method is part of quality assurance in the process chain of industrialized additive manufacturing.

A further aspect of the present invention relates to a device for performing the method, for example comprising equipment or an interface for providing the measured data.

A further aspect of the present invention relates to a computer program product, comprising program commands which, when the program is executed by a computer, cause the latter to perform the method as described.

For example, a CAD file or a computer program product can be provided or available as (volatile or nonvolatile) storage or reproduction medium, for example a memory card, a USB stick, a CD-ROM or DVD, or else in the form of a file that is downloadable from a server and/or in a network. For example, the provision can also be implemented in a wireless communications network by the transfer of a corresponding file with the computer program product.

The computer program product can also contain geometry data and/or construction data in a data record or data format, for example a 3-D format or as CAD data, or comprise a program or program code for the provision of these data.

A further aspect of the present invention relates to a provision device for the computer program product, the provision device being able to store and/or provide the computer program product.

Configurations, features and/or advantages relating to the method or the computer program product in the present case may also relate to the device(s), and vice versa.

When applied to a list of two or more elements, the expression “and/or” or “or” as used herein means that each of the listed elements can be used on its own, or use can be made of any combination of two or more of the listed elements.

### BRIEF DESCRIPTION OF THE DRAWINGS

Further details of the invention are described below on the basis of the figures.

FIG. 1 shows a schematic flowchart of the procedure according to the invention.

FIG. 2 schematically shows an exemplary model slice or a computer program product displaying the latter, in which the method according to the invention cannot recognize any structural defects.

FIG. 3 schematically shows an exemplary model slice or a computer program product displaying the latter, in which a structural defect is recognized by the method according to the invention by way of an area adjustment.

### DETAILED DESCRIPTION OF INVENTION

In the exemplary embodiments and figures, the same elements or elements with the same effect may be provided with the same reference sign in each case. The depicted elements and the size proportions of the depicted elements with respect to one another should not be considered true to scale as a matter of principle; instead, individual elements may be depicted exaggeratedly thick or largely dimensioned for better representability and/or for better comprehensibility.

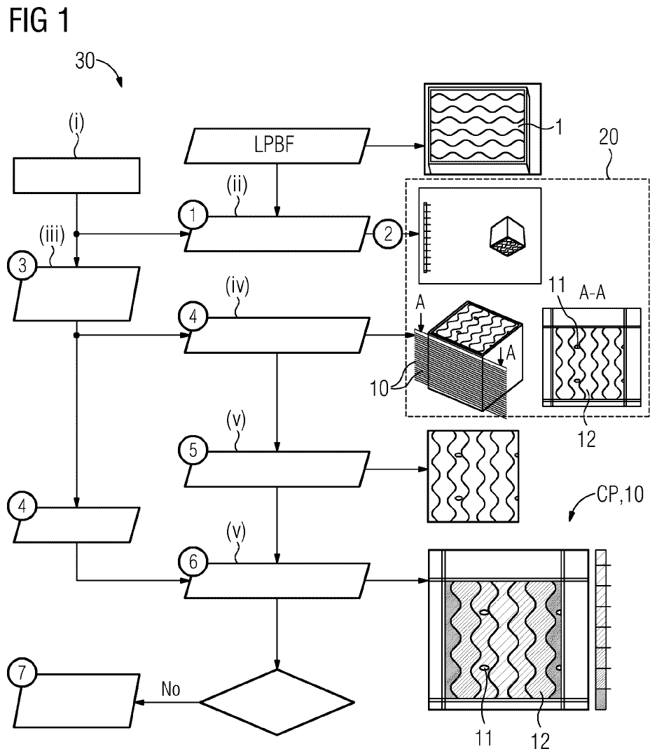

FIG. 1 indicates the procedure according to the invention on the basis of a schematic flowchart. The method according to the invention is a method of nondestructive material testing which is applied, for example as a part of or in part, in quality assurance of industrialized production processes, especially additive processes.

The method comprises, (i), the provision of a target geometry of a component 1 with the aid of a 3-D data model of the component 1. By preference, the target geometry is provided by a 3-D CAD data record.

The method also comprises, (ii), the provision of measured data of the component 1, the measured data being generated by an imaging method. By preference, the measured data are generated by a tomographic method, especially computed tomography (CT).

Alternatively, the means for providing the measured data can be an alternative tomographic or imaging method, for example conventional x-ray tomography, ultrasound diagnostics (sonography), nuclear magnetic resonance (NMR), positron emission tomography (PET), single photon emission computed tomography (SPECT), optical coherence tomography (OCT), electrical impedance tomography (EIT), digital volume tomography (DVT), or similar methods.

The method also comprises, (iii), the overlay of the measured data CT of the component 1 on the 3-D data model. In particular, the overlay may comprise or represent an alignment of the 3-D data model with the measured data CT of the component 1 by way of a compensating adaptation.

The method also comprises, (iv), the provision of 2-D model slices 10 by cutting the data model with the overlaid measured data. In this case, a layer or slice spacing between individual layers of the data model can be roughly between 0.01 mm and 0.2 mm, preferably between 0.01 mm and 0.1 mm, and particularly preferably between 0.01 mm and 0.05 mm.

The method additionally also comprises, (v), the examination of each 2-D model slice 10, or each significant or relevant 2-D model slice, for structural differences between the data model and the measured data using an automated image analysis, with for example a distinction being made between solid component features 11, such as welding splashes or sintered particles, and hollow component features or cavities 12. Further, the automated image analysis can be used to measure an area 12 enclosed by component features and perform an area adjustment with the data model (see below).

In the drawing of FIG. 1, reference sign 20 should further indicate a device 20 for performing a method.

A work or test result of the described method can presently be available, communicated and transmitted as a computer program product CP, for example. By preference, such a computer program product CP comprises program commands which, when the program is executed by a computer, cause the latter to carry out the method.

Further, reference sign 30 denotes a provision device for the computer program product CP, said provision device preferably being configured to store and/or provide the computer program product CP.

In other words and with reference to the circled numbers of the individual process steps, the procedure according to the invention can be described as follows:
According to the step labeled (1) (cf. (ii)), the component for example produced additively by LPBF is subject to a computed tomography recording post manufacture.

According to step (2), this can be followed by a visualization of the measured CT data by means of a 3-D data analysis software such as “Volume Graphics”.

According to step (3), the CT data and initial CAD data are aligned. A best fit is used to overlay the two component geometries or models on one another in order to define the construction direction or orientation. Since the separation from the building platform leads to non-definable volume losses on the lower side of the component, it is important to use the upper plane as reference surface for the alignment.

According to step (4), the data (CAD and CT) are now sliced or cut. The spacing should be between 0.01 mm and 0.05 mm in order to detect all possible and/or significant or relevant defects.

According to step (5), the slice images are now analyzed or tested algorithmically by way of pattern or image recognition software, for example “MIPAR”. In the process, the individual chambers, segments, features or portions are analyzed for their respective area, by preference in a targeted manner in each plane (model slice). In order to achieve this, a distinction between solid and hollow component features (solid versus non-solid) is preferably made at first.

According to step (6), the area or a surface area corresponding to the aforementioned chambers, segments or regions is subsequently measured and aligned with the likewise sliced CAD model. If the areas or the numbers of chambers in a slice plane deviate, a breakthrough is identified (cf. FIG. 3 below), and a user is informed about the number of defective component regions and the associated model slice (plane).

According to additional step (7), an alignment with the employed scanning strategy can also still be implemented. To this end, use can be made of for example additional data of the process, which might only be available in 2-D, e.g. the scanning vectors, irradiation parameters such as laser power, a position of the component in the installation space of a corresponding production apparatus, or further (CAM) control instructions for the individual layers (CAM), or layer-based (in situ) monitoring data. For example, all of this information can be evaluated with computer assistance and/or using machine learning methods.

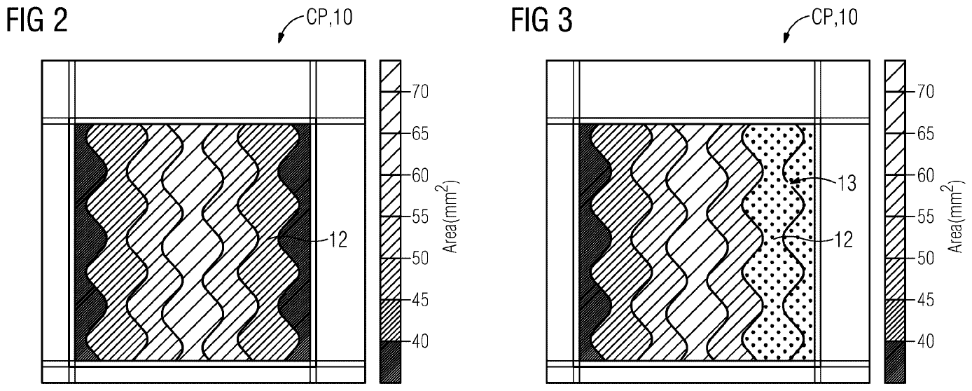

According to the model slices also depicted on the basis of FIG. 1 or according to the (aligned) information from the measured data, it is possible to quickly identify whether (cf. FIG. 2) or not (cf. FIG. 3) a structural defect is present even in very thin-walled component structures, especially by way of the described area measurement.

An example for recognizing a defect is depicted in FIG. 2 in particular.

FIG. 3 shows a recognized structural defect 13, in particular a structural breakthrough or a defect, between the two component chambers on the right-hand side of the drawing. In fact, the described target/actual comparison automatically leads to an increased area in this way. Such information can advantageously be output to a user of the method as the result of the material test.

It is made clear that the wavy walls of the slice images in FIGS. 2 and 3 are indicated purely by way of example and quality; however, the described procedure is also applicable without loss of generality to entirely deviating component shapes or structure portions.

The presently depicted wavy structures may represent slices of a structure for a heat exchanger or an additively manufactured heat transmitter in particular.

The identification of defects in the target/actual comparison might be more complicated in the case of other geometries, for example those with smaller cells, chambers or contiguous features. As indicated above, “machine learning” can be applied and also implemented easily for the purpose of improving the accuracy and reliability, in particular in order to define the threshold values in accordance with the described boundary conditions. The model can also be used within the scope of cleansing or correcting image artifacts (cf. (5)), in particular in order to identify sintered or agglomerated particles.

In addition to the above-described area comparison, it is also possible to perform a shape comparison, for example of component contours or thin walls of the component.

As an alternative to the described heat transfer and cooling structures, the component present can be a component of a turbomachine, for example a component of the hot gas path of a gas turbine. In particular, the component can be a rotor blade or guide vane, a ring segment, a combustion chamber or burner part, for example a burner tip, a frame, a shield, a heat shield, a nozzle, a seal, a filter, an opening or lance, a resonator, a stamp or an agitator, or a corresponding transition, insert, or a corresponding retrofitted part.

1-13. (canceled)

14. A method of nondestructive material testing, comprising:
(i) providing a target geometry (CAD) of a component with the aid of a 3-D data model of the component,
(ii) providing measured data of the component, the measured data (CT) being generated by an imaging method,
(iii) overlaying the measured data (CT) of the component on the 3-D data model,
(iv) providing 2-D model slices by cutting the data model with the overlaid measured data, a slice spacing between individual layers of the data model corresponding to a value roughly between 0.01 mm and 0.05 mm, and
(v) examining each 2-D model slice for structural differences between the data model and the measured data using an automated image analysis.

15. The method as claimed in claim 14, wherein the target geometry (CAD) is provided by a 3-D CAD data record.

16. The method as claimed in claim 14,
wherein the measured data (CT) are generated by a tomographic method or computed tomography.

17. The method as claimed in claim 14,
wherein the overlay comprises or represents an alignment of the 3-D data model with the measured data (CT) of the component by way of a compensating adaptation.

18. The method as claimed in claim 14,
wherein the automated image analysis for the examination of each model slice includes distinguishing between solid and hollow component features.

19. The method as claimed in claim 14,
wherein the automated image analysis for the examination of each model slice includes measuring an area enclosed by component features and performing an area adjustment with the data model.

20. The method as claimed in claim 19,
wherein a component material, a scanning parameter comprising an irradiation power or an irradiation pattern, and/or a position of the component in an installation space are given consideration during the measurement of the area.

21. The method as claimed in claim 14,
wherein machine learning methods are applied during the automated image analysis.

22. The method as claimed in claim 14,
which is part of quality assurance in a process chain of industrialized additive manufacturing.

23. A device for performing a method as claimed in claim 14.

24. A computer program product (CP) stored on a non-transitory computer readable media, comprising:
program commands stored thereon which, when the program is executed by a computer, cause the computer to perform the method as claimed in claim 14.

25. A provision device for the computer program product as claimed in claim 24,
the provision device storing and/or providing the computer program product (CP).
